(19) United States
(12) Patent Application Publication
(10) Pub. No.: US 2018/0177207 A1
(43) Pub. Date: Jun. 28, 2018

(54) A CONFECTONERY PRODUCT

(71) Applicant: AAK AB (publ), Malmö (SE)

(72) Inventors: Morten Daugaard ANDERSEN, Højbjerg (DK); Karsten NIELSEN, Tranbjerg (DK)

(21) Appl. No.: 15/580,590

(22) PCT Filed: Jun. 9, 2016
(86) PCT No.: PCT/SE2016/050558

§ 371 Date: Dec. 7, 2017

(30) Foreign Application Priority Data
Jun. 10, 2015 (SE) 1550784-1

(51) Int. Cl. A23G 1/36; A23G 1/30

(52) U.S. Cl. CPC A23G 1/36; A23V 2002/00; A23G 1/305

(57) ABSTRACT

The invention relates a confectionery product comprising chocolate, wherein the chocolate has a fat phase comprising 60.0-99.9% by weight of triglycerides, 40.0-99.0 by weight of triglycerides having C16-C20 saturated fatty acids in the sn-1 and sn-3 positions of the triglyceride and oleic acid in the sn-2 position of the triglyceride, wherein the chocolate has a texture ratio of between 0.8 and 1.1, wherein the texture ratio determines the increase between an initial texture value and a subsequent texture value, wherein the initial texture value is measured prior to a temperature treatment and wherein the subsequent texture value is measured subsequent to the temperature treatment, wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer.

### BACKGROUND OF THE INVENTION

A well-known challenge in relation to chocolate is that chocolate is sensitive to heat. In certain climate such heating is typically not really a problem or may only be a challenge during specific season(s). When a chocolate, such as a chocolate bar, chocolate pralines or the like becomes subject to undesired heating such as from sunlight the chocolate confectionery will start melting and the confectionery properties may be irreversibly lost. Thus, an ideal storage temperature for chocolate confectionery is by some regarded to be between 15 and 21 degrees Celsius with a relatively humidity of less than about 50%. Such storage or use conditions may nevertheless be very difficult to comply with throughout the life-cycle of a chocolate confectionery.

Heating of chocolate may of course be counteracted throughout the complete supply chain until the consumer finally acquires the chocolate or at least in parts of the supply chain until the chocolate confectionery product is delivered to the location for sale, such as kiosks, super markets, cafés etc.

From thereon it nevertheless becomes a little more complicated insofar the user may have less options of controlling the storage or use temperature.

One of several undesired results of overheating is that the chocolate may melt and lose its original form and structure as the fat crystals melt. When the chocolate is cooled down again it may not regains it's original structure, it may become much softer due to insufficient re-crystallisation or it may become harder and grainy due to uncontrolled crystallisation, all dependent on the temperature and cooling process. Another problem is that chocolate, when cooled down subsequent to overheating may suffer from so-called blooming. The blooming makes the chocolate less appealing, in particular when the original form of the chocolate confectionery has changed visibly.

### SUMMARY OF THE INVENTION

The invention relates to a confectionery product comprising chocolate, wherein the chocolate has a fat phase comprising 60.0-99.9% by weight of triglycerides, 40.0-99.0 by weight of triglycerides having C16-C20 saturated fatty acids in the sn-1 and sn-3 positions of the triglyceride and oleic acid in the sn-2 position of the triglyceride,

wherein the chocolate has a texture ratio of between 0.8 and 1.1, wherein the texture ratio determines the increase between an initial texture value and a subsequent texture value,

wherein the initial texture value is measured prior to a temperature treatment and wherein the subsequent texture value is measured subsequent to the temperature treatment,

wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer.

According to an advantageous embodiment of the invention, the obtained confectionery product is texture stable in the sense the texture properties are preserved or recovered subsequent to a normally disruptive heating cycle, e.g. said temperature treatment. A texture stable confectionery product in the present context is referring to the fact that the texture of the provided confectionery product has a surprisingly and acceptable mouthfeel compared to conventional chocolate. In the present context it should be noted that a mouthfeel has several dimensions not hitherto exploited. The preservation of such mouthfeel or recovery of the pleasant mouthfeel has previously been disregarded or lower prioritized physical appearances, such as blooming or form stability.

### DETAILED DESCRIPTION

### Definitions

As used herein, the term “fatty acid” encompasses free fatty acids and fatty acid residues in triglycerides.

As used herein “edible” is something that is suitable for use as food or as part of a food product, such as a dairy or confectionary product. An edible fat is thus suitable for use as fat in food or food product and an edible composition is a composition suitable for use in food or a food product, such as a dairy or confectionary product.

As used herein, “%” or “percentage” all relates to weight percentage i.e. wt. % or wt. % if nothing else is indicated.

As used herein, the singular forms “a”, “an” and “the” include plural referents unless the context clearly dictates otherwise.

As used herein, “vegetable oil” and “vegetable fat” is used interchangeably, unless otherwise specified.

As used herein, “at least one” is intended to mean one or more, i.e. 1, 2, 3, 4, 5, 6, 7, 8, 9, 10, etc.

As used herein, the term “main endotherm melt peak position” may refer to the peak having the largest integral and/or as the peak having the largest maximum value.

As used herein, the term “endotherm melt peak position” may refer to the position of a melt peak, which may be the main endotherm melt peak or it may be a smaller melt peak.

As used herein, the term “vegetable” shall be understood as originating from a plant retaining its original chemical structure/composition. Thus, a vegetable fat or vegetable triglycerides are still to be understood as vegetable fat or vegetable triglycerides after fractionation etc. as long as the chemical structure of the fat components or the triglycerides are not altered. When vegetable triglycerides are for example transesterified they are no longer to be understood as a vegetable triglyceride in the present context.

Similarly, the term “non-vegetable” in the context of “non-vegetable triglyceride” or “non-vegetable fat” when used herein is intended to mean obtained from other sources than native vegetable oils or fractions thereof, or obtained after transesterification.

As used herein, “transesterification” should be understood as replacing one or more of the fatty acid moieties of a triglyceride with another fatty acid moiety or exchanging one or more fatty acid moieties from one triglyceride molecule to another. A fatty acid moiety may be understood as a free fatty acid, a fatty acid ester, a fatty acid anhydride, an activated fatty acid and/or the fatty acyl part of a fatty acid. The term ‘transesterification’ as used herein may be used interchangeably with ‘interesterification’. The transesterification process may be an enzymatic transesterification or chemical transesterification. Both chemical transesterification and enzymatic transesterification is described well in the art. Both chemical and enzymatic transesterification may be done by standard procedures.

As used herein “partly melted” is intended to mean not totally melted and not totally solid or crystalline. Within a certain temperature range the seed product has to be melted enough to be pumpable, and may not be melted to an extent that no seed crystals capable of seeding chocolate remains. In certain embodiments partly melted may be understood more narrow, for example that a certain percentage is melted and a certain percentage is non-melted, i.e. solid or crystalline. This may for example be represented by the solid fat content (SFC). Several methods for measuring SFC are known in the art.

As used herein, the term “slurry” is a partly melted composition, where at least some seed crystals capable of seeding chocolate are present. Thus, a “slurry” may also for example be understood as a partly melted suspension, partly molten suspension or a paste.

As used herein, the term “fraction” shall in this regard be understood to be a product remaining after a physical separation of the constituents of a natural source of a fat. This product may subsequently be subjected to a transesterification.

As used herein “crystalline seed” is intended to mean a seed comprising crystals capable of seeding a chocolate in predominantly form V. The crystalline seed may be solid or it may be partly melted, such as for example in a slurry, partly molten, paste-like state. When solid, the crystalline seed may be in the form of particles, where such particles include flakes, pellets, granules, chips, and powder.

Seeding is a well-known technology within the chocolate art. A seed product as described herein may be obtained by various processes known to the skilled person as long as the crystalline seed product has a sufficiently high endotherm melt peak position and as long as a relatively high melting point is also reflected in the final chocolate composition. One method for obtaining suitable seed material having a main endotherm melt peak position of about 40 degrees Celsius or higher may be to melt the vegetable fat comprised in the seed composition or fractions thereof by applying heat, followed by storage of the vegetable fat or fractions thereof at a temperature lower than about 40 degrees Celsius, for example at about 37 degrees Celsius, for about 20 hours. This seed material may be partly melted prior to mixing into the chocolate or it may be mixed into a suspension and then mixed into the chocolate composition. Other methods to obtain the desired high melting seed crystals of in particular StOSt-based seed crystals may be applied within the scope of the invention. Such high melting crystals may e.g. include crystals melting above 40 degrees Celsius.

As used herein a “chocolate” is to be understood as chocolate and/or chocolate-like products. Some chocolate comprises cocoa butter, typically in substantial amounts, where some chocolate-like product may be produced low or even without cocoa butter, e.g. by replacing the cocoa butter with cocoa butter equivalent, cocoa butter substitute, etc. Also, many chocolate products comprise cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate. By a chocolate product is meant a product, which at least is experienced by the consumer as chocolate or as a confectionery product having sensorial attributes common with chocolate, such as e.g. melting profile, taste etc.

As used herein the term “seed product” is intended to mean a seed product comprising seed. The seed product may be provided as solid seed particles, or as a seed slurry. The particles may be in various forms, examples of which include flakes, pellets, granules, chips, and powder. The seed product is for use in seeding chocolate. This may optionally be done in combination with conventional tempering steps. It is noted that a seed product which is partly melted during mixing with the chocolate composition or partly melted prior to mixing with the chocolate composition is very advantageous for the purpose of obtaining a chocolate which may recrystallize to a desired texture after being subjected to heating which partly melts the chocolate confectionery.

As used herein the term “texture analyzer” is intended to broadly designate any suitable and appropriate measuring apparatus which may be used for measuring and quantifying texture estimates such as hardness, brittleness, fracturability, adhesiveness, stiffness, elasticity, bloom strength, etc.

The invention relates to a confectionery product comprising chocolate, wherein the chocolate has a fat phase comprising
60.0-99.9% by weight of triglycerides,
40.0-99.0 by weight of triglycerides having C16-C20 saturated fatty acids in the sn-1 and sn-3 positions of the triglyceride and oleic acid in the sn-2 position of the triglyceride,

wherein the chocolate has a texture ratio of between 0.8 and 1.1,

wherein the texture ratio determines the increase between an initial texture value and a subsequent texture value,

wherein the initial texture value is measured prior to a temperature treatment and

wherein the subsequent texture value is measured subsequent to the temperature treatment,

wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer.

It should be understood that the triglycerides having C16-C20 saturated fatty acids in the sn-1 and sn-3 positions of the triglyceride and oleic acid in the sn-2 position of the triglyceride, form part of the total amount of triglycerides comprised in the fat phase of the heat stable chocolate.

Since 60.0-99.9% by weight of the fat phase is triglycerides, 0.1-40% by weight of the fat phase may be other fats than triglycerides, such as free fatty acids, monoglycerides, diglycerides or any combination thereof.

Further, 40.0-99.0% by weight of said triglycerides are triglycerides having C16-C20 saturated fatty acids in the sn-1 and sn-3 positions of the triglyceride and oleic acid in the sn-2 position of the triglyceride. Examples of such triglycerides having C16-C20 saturated fatty acids in the sn-1 and sn-3 positions of the triglyceride and oleic acid in the sn-2 position of the triglyceride are StOSt, POSt, POP, StOA, POA and AOA. Thus, if the fat phase for example comprises 60% triglycerides, then 40%-99% of said 60% triglycerides are triglycerides having C16-C20 saturated fatty acids in the sn-1 and sn-3 positions of the triglyceride and oleic acid in the sn-2 position of the triglyceride, which in this case would mean that the fat phase then comprises 24%-59.4% of triglycerides having C16-C24 saturated fatty acids in the sn-1 and sn-3 positions of the triglyceride and oleic acid in the sn-2 position of the triglyceride.

According to an advantageous embodiment of the invention, the obtained confectionery product is texture stable in the sense the texture properties are preserved or recovered subsequent to a normally disruptive heating cycle, e.g. said temperature treatment. A texture stable confectionery product in the present context is referring to the fact that the texture of the provided confectionery product has a surprisingly and acceptable mouthfeel compared to conventional chocolate. In the present context it should be noted that a mouthfeel has several dimensions not hitherto exploited. The preservation of such mouthfeel or recovery of the pleasant mouthfeel has previously been disregarded or lower prioritized physical appearances, such as blooming or form stability.

It should be noted that the testing sequence is applied for the skilled person to recognize whether the chocolate has the intended properties or in the sense that structure as such cannot be an indicator of the desired property. The desired texture may thus be obtained through triglycerides having a certain formulation and also an effective crystalline structure. An effective crystalline structure in the chocolate will thus result in a proper regeneration of texture, whereas the lack of such crystals, even in a chocolate having the same chemical composition will not result in such regeneration of texture.

Different determining factors besides the presence of triglycerides having the desired crystal forms may also include the amount of the applied triglyceride seed. An advantageous indicator of whether a chocolate product has the desired structure and physical property is to provide a chocolate having an endotherm melt peak position which is 37 degrees Celsius or higher. The melt peak position is indicative of whether the desired triglyceride crystals are present in the chocolate.

The application of a texture value is thus not just wishful thinking but merely a way to determine whether the triglycerides have been applied according to the invention and an important measure to obtain this chemical and physical structure is to apply chocolate triglycerides having a high endotherm melt peak position in the chocolate and through appropriate seeding.

In the present context, it should be noted that a typical use of seed in chocolate is to expedite the tempering process. In the present context any tempering process is merely a measure which has to fit into the final goal of providing a chocolate with the right triglyceride crystal structure in the finally produced chocolate. In other words, seeding for tempering purposes does not necessarily result in a texture which may be regenerated upon partly melting.

Bloom resistance is thus not a primary consideration due to the fact that desired goal is to obtain a chocolate which may regain its textural properties after partly melting of the chocolate, e.g. due to elevated ambient temperature. According to an advantageous embodiment of the invention, this recovery of texture may be obtained through use of appropriate triglyceride crystals in the manufactured chocolate.

A texture ratio above 1.0 is understood as an increase in the given texture value after the temperature treatment has occurred and where a texture ratio below 1.0 indicates that the value has decreased subsequent to the temperature treatment. Texture stability is in fact a very important measure and this is in particular due to the fact that some chocolate blooming and texture sensation are two different factors.

The present invention provides a heat-stable chocolate which, even when a chocolate is partly melted and has lost its original shape may recover the textural properties due to the applied crystalline seed. These crystals are preferably relatively high melting, i.e. melting at temperatures at above about 37 degrees Celsius and that the chocolate is rich in triglycerides having C16-C20 saturated fatty acids in the sn-1 and sn-3 positions of the triglyceride and oleic acid in the sn-2 position of the triglyceride.

According to an embodiment it should be understood that the increase between the initial texture value and the subsequent texture value may be positive or negative.

It may be advantageous to obtain a confectionery product with chocolate having an endotherm melt peak position, which is relatively high due to the fact that this seed, provided that the added seed results in an increased endotherm melt peak position of the final chocolate may assist in a proper re-crystallization of the chocolate if a partly melted chocolate subsequently is cooled. This so-called proper re-crystallization is very important in relation to embodiments of the present invention due to the fact that a very important goal according to advantageous embodiments of the invention is to ensure that the texture of a partly melted chocolate is regained if the chocolate is subsequently cooled. To a user it is more important that the texture is nice and complying with what a user will expect from a chocolate whereas e.g. a change in form of the chocolate may be acceptable.

Therefore, in an embodiment of the invention, the endotherm melt peak position of said chocolate is about 37 degrees Celsius or higher, such as about 38 degrees Celsius or higher, when measured by Differential Scanning calorimetry by heating samples of 40+/−4 mg of heat stable chocolate from 30 degrees Celsius to 65 degrees Celsius at a rate of 3 degrees Celsius per minute to produce a melting thermogram defining said endotherm melt peak position.

It has been found that small amounts of fat crystals with higher melting points, for example having endotherm melt peak positions above 37 degrees Celsius, such as above 38 degrees Celsius, when measured by DSC, may be obtained in the embodiments according to the present invention when compared to standard tempering, which may typically provide endotherm melt peak positions around 30-33 degrees Celsius, depending on the specific recipe and fat composition. Furthermore, it may be beneficial in addition to the crystalline seed to add an amount of fat such as a cocoa butter improver to the fat phase to obtain an advantageous confectionery product. The DSC melt peak position of the seed may be shifted to a lower value when present in a fat phase comprising other components/compositions than the seed alone, and this phenomenon may be due to an eutectic effect.

The exact position of the endotherm melt peak positions may vary, e.g. due to the specific content of triglycerides and different polymorphic crystal forms. In an embodiment of the invention an endotherm melt peak position of the chocolate is between about 37-40 degrees Celsius, when measured by Differential Scanning calorimetry by heating samples of 40+/−4 mg of heat stable chocolate from 30 degrees Celsius to 65 degrees Celsius at a rate of 3 degrees Celsius per minute to produce a melting thermogram defining the endotherm melt peak position. An endotherm melt peak position of the heat stable chocolate between about 37-40 degrees Celsius is obtainable, when the seed comprised in the fat phase of the chocolate comprises at least 40% StOSt. The seed may in this case be present in the fat phase in an amount of at least 1% by weight.

In a further embodiment of the invention the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and

wherein the initial and the subsequent texture values are measured on a Stable Micro System texture analyzer TA-XT2i with a Stable Micro Systems 2 mm needle probe P2N set to penetrate into the samples at 0.5 mm/second and wherein the samples are measured at 25+/−0.5 degrees Celsius. The needle probe P2N may be set to a penetration at least 1, such as 2, such as 3, such 4 millimeters into the samples thereby ensuring that a reliable measure is obtained. In an embodiment of the invention said samples have a thickness sufficient to form substance for the penetration. In other words, the thickness should be greater than the set penetration.

In still a further embodiment the fat phase comprises 70.0-99.9% by weight of triglycerides, such as 80.0-99.0% by weight of said fat phase.

In still a further embodiment the fat phase comprises 50.0-95.0%, such as 60-90% by weight of triglycerides having C16-C20 saturated fatty acids in the sn-1 and sn-3 positions of the triglyceride and oleic acid in the sn-2 position of the triglyceride.

In a further embodiment the chocolate has a fat phase comprising
60.0-99.9% by weight of triglycerides,
40.0-99.0 by weight of triglycerides having C16-C20 saturated fatty acids in the sn-1 and sn-3 positions of the triglyceride and oleic acid in the sn-2 position of the triglyceride,

wherein the chocolate has a texture ratio of between 0.8 and 1.1,

wherein the texture ratio determines the increase between an initial texture value and a subsequent texture value,

wherein the initial texture value is measured prior to a temperature treatment and

wherein the subsequent texture value is measured subsequent to the temperature treatment,

wherein the temperature treatment is obtained by providing five samples of said chocolate each weighing 100 grams and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius 24 hours, and

wherein the initial and the subsequent texture values are measured on a Stable Micro System texture analyzer TA-XT2i with a Stable Micro Systems 2 mm needle probe P2N set to penetrate 3 mm into the samples at 0.5 mm/second and wherein the samples are measured at 25+/−0.5 degrees Celsius.

The measured texture values may be obtained as an average of the measured texture values across a measuring sequence of measures on said samples and a standard deviation of the measured texture values are less than about +/−20% over a measuring sequence of measures on said samples.

The texture ratio applied in the present context is used to characterize the final product due to the fact that a pure designation of chemical composition does not suffice. It is well-known that chocolate known in the prior art lacks the ability to regenerate property once partly melted. It is also well-known to use seeds e.g. for obtaining an efficient tempering of a chocolate-containing product still without obtaining an advantageous confectionery product which may regain its textural property after a partly melting.

In the present application a proper and reproducible method to designate the product to be obtained has been disclosed and the chemical structure and the required process to obtain the unique result has been disclosed, thereby enabling the skilled person to obtain the desired product. An advantageous way of obtaining a proper seeding is to seed the chocolate so that the final chocolate has an endotherm melt peak position which is higher that the un-seeded chocolate composition.

The setting of the penetration should advantageously be as high as possible when considering thickness of the sample such that the standard deviation of the measurements is as low as possible.

In a further embodiment of the invention said chocolate is forming a coating of said confectionery product.

The chocolate may form part of a coating of a confectionery product. It is thereby obtained that the texture-stable properties of the coating may improve both the visible appearance of the confectionery texture subsequent to heating above e.g. 36 degrees Celsius. A coating in the present context is understood broadly as enrobing or partly covering of a confectionery center. The coating may be subjected in many different ways as long as the coating is subjected to the confectionery product at sufficient low temperature. It should nevertheless be noted that the temperature in the present context may be relatively high compared to conventional coating method. In advantageous embodiments of the invention said chocolate may be subjected to a confectionery center at a temperature of 35-42 degrees Celsius depending on the applied triglycerides and the applied form of the respective fat crystals of the seed product.

One way of obtaining a confectionary product having a melt peak position of about 37 degrees Celsius or higher may be by adding a seed product in an amount of 0.1-15% by weight of the fat phase, wherein an endotherm melt peak position of said seed product is about 40 degrees Celsius or higher when measured by Differential Scanning calorimetry by heating samples of 10+/−1 mg of seed product from 20 degrees Celsius to 65 degrees Celsius at a rate of 3 degrees Celsius per minute to produce a melting thermogram defining said endotherm melt peak position.

According to an embodiment of the invention, the melting thermogram of the seed product is obtained by Differential Scanning calorimetry (DSC) by a METTLER TOLEDO DSC 823e with a HUBER TC45 immersion cooling system, where 10+/−1 mg samples of the chocolate confectionery product is hermetically sealed in a 40 microliter aluminum pan with an empty pan as reference and where the samples are heated from 20 degrees Celsius to 65 degrees Celsius at a rate of 3 degrees Celsius per minute to produce a DSC melting thermogram.

In further embodiment of the invention the confectionery product in its embodiments is forming by said chocolate. The confectionery product may thus also be a massive praline, bar, etc. formed by said chocolate.

In further embodiment of the invention said chocolate is forming at least a part of said confectionery product confectionery product in all its embodiments. The chocolate may also be only a part of the confectionery product and may thus be combined with other types of confectionery, such as biscuits, waffles, gum, licorice, more conventional confectionery fillings, etc.

In a further embodiment of the invention the confectionery product said chocolate has an endotherm melt peak position at least 37 degrees Celsius on a DSC melting thermogram of said chocolate and wherein said a DSC melting thermogram is measured by differential scanning calorimetry by heating samples of 10+/−1 mg of said chocolate from 20 degrees Celsius to 65 degrees Celsius at a rate of 3 degrees Celsius/min to produce a melting thermogram defining first and second endotherm melt peak position.

In a further embodiment of the invention the confectionery product said chocolate has an endotherm melt peak position at least 37 degrees Celsius on a DSC melting thermogram of said chocolate and wherein said a DSC melting thermogram is measured by differential scanning calorimetry by heating samples of 10+/−1 mg of said chocolate from 20 degrees Celsius to 65 degrees Celsius at a rate of 3 degrees Celsius/min to produce a melting thermogram defining said endotherm melt peak position.

An important factor in obtaining the claim desired textural properties may thus be obtained while ensuring that the melt peak position of the applied seed is still reflected in the chocolate. This may be the case insofar seeding is used for conventional tempering or chocolate processing purposes.

According to an advantageous embodiment of the invention, a chocolate has been obtained which is robust to ambient temperature and the confectionery exhibits advantageous textural properties in the sense that the seed crystals in the confectionery in practice may invoke an impressing recovery of form V crystals in the confectionery product even if a large part of form V crystals of the confectionery product has melted. This recovery, of course requires that the temperature subsequent to the partly melting of the confectionery product lowers enough to facilitate reestablishment of form V crystals.

In a still further embodiment said chocolate of the confectionery product has an endotherm melt peak position of at least 37.2, such as 37.4, such as 37.6, such as 37.8 degrees Celsius.

One way of obtaining a confectionary product having a melt peak position of about 37 degrees Celsius or higher may be by adding a seed product in an amount of 0.1-15% by weight of the fat phase, wherein an endotherm melt peak position of said seed product is about 40 degrees Celsius or higher when measured by Differential Scanning calorimetry by heating samples of 10+/−1 mg of seed product from 20 degrees Celsius to 65 degrees Celsius at a rate of 3 degrees Celsius per minute to produce a melting thermogram defining said endotherm melt peak position.

According to an embodiment of the invention, the melting thermogram of the seed product is obtained by Differential Scanning calorimetry (DSC) by a METTLER TOLEDO DSC 823e with a HUBER TC45 immersion cooling system, where 10+/−1 mg samples of the chocolate confectionery product is hermetically sealed in a 40 microliter aluminum pan with an empty pan as reference and where the samples are heated from 20 degrees Celsius to 65 degrees Celsius at a rate of 3 degrees Celsius per minute to produce a DSC melting thermogram.

According to a further embodiment of the invention the chocolate has an endotherm melt peak position which is at least 37.0, such as 37.2, such as 37.4, such as 37.6, such as 37.8 degrees Celsius representing an endotherm enthalpy minimum of 0.1 J/g, such as 0.15 J/g , such as 0.2 J/g or such as 0.3 J/g, where the minimum intensity is measured as Joule/gram.

According to a further embodiment of the invention the endotherm melt peak position of the DSC thermogram of the chocolate has a minimum intensity of 0.1 J/g, such as 0.15 J/g, such as 0.2 J/g or such as 0.3 J/g, where the minimum intensity is measured as Joule/gram.

The chocolate also comprises fat insoluble particles. In a further advantageous embodiment of the invention said chocolate of said confectionery product comprises sugar having a particle size of less than 50, such as less than 40, such as less than 30, such as less than 25 micrometer.

In an advantageous embodiment of the invention the chocolate of the confectionery product and all of its embodiments comprise sugar having a particle size of less than 50, such as less than 40, such as less than 30, such as less than 25 micrometer and where the particle size is measured by means of a digital micrometer from Mitutoyo Coolant Proof serie 293-240 and where the particle size is measured by
(a) mixing a solution of 50% by weight of soy lecithin and 50% by weight of paraffin oil at 50 degrees Celsius
(b) calibrating the micrometer to ensure a correct measurement,
(c) providing a chocolate sample by mixing 20% by weight of the chocolate confectionery product and mixing it with 80% by weight with the solution provided in step (a),
(d) screwing measuring faces of the micrometer gently together until a first click indicates a maximum force on the measuring faces and then
(e) reading the micrometer to obtain a measure of the particle size.

This measuring method is attractive as it is easy to make in a reproducible way although the measuring as such may influence the particle size.

The particle size of sugar particles may of course therefore be measured in many different ways, e.g. also considering standard deviation, ranges, mean particle size, etc., but the present stated method is known and applied within the art to provide a suitable estimate of the size of sugar particles or other powders particles in a chocolate confectionery product.

It should in particular be noted that the particle size of sugar is a very relevant parameter in relation to the present invention where texture of the confectionery product is in question and where sugar particles may amplify a negative texture sensation occurred due to heating and un-tempering of a confectionery product or alternatively support the very attractive textural properties of the invention.

In a further embodiment the confectionery product comprises a seed product which comprises a seed composition.

In a still further embodiment of the invention the fat phase of the chocolate comprises 70.0-99.9% by weight of triglycerides, such as 80.0-99.9% by weight, such as 90.0-99.9% by weight, such as 95.0-99.9% by weight.

In a still further embodiment of the invention the fat phase of the chocolate comprises 50.0-99.0% by weight of triglycerides having C16-C20 saturated fatty acids in the sn-1 and sn-3 positions and oleic acid in the sn-2 position of the triglyceride, such as 60.0-99.0% by weight, such as 70.0-99.0% by weight.

The triglycerides having C18-C20 saturated fatty acids in the sn-1 and sn-3 positions of the triglyceride and oleic acid in the sn-2 position of the triglyceride are part of the SatOSat-triglycerides.

In still further embodiments of the invention the fat phase has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,

which is between 0.40-0.99, such as 0.45-0.99, such as 0.50-0.99, such as 0.55-0.99, such as 0.60-0.99, such as 0.65-0.99, such as 0.70-0.99.

In still further embodiments of the invention the fat phase has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,

which is between 0.40-0.99, such as 0.45-0.99, such as 0.50-0.99, such as 0.55-0.99, such as 0.60-0.99, such as 0.65-0.99, such as 0.70-0.99

According to this advantageous embodiment of the invention, the amount of a StOSt in the fat phase of the chocolate composition is relatively high, and this amount will together with high melting point seed crystals in the chocolate composition provide a a chocolate composition which may regain its texture while re-crystallizing after a partial melting of the chocolate product.

In still further embodiments of the invention the fat phase of the inventive chocolate has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,

which is between 0.40 and 0.50. One advantage of this embodiment may that a combination of a relatively bloom-stable chocolate with good texture and sensoric properties. This may be particularly advantageous when using an emulsifier not being lecithin, for example an emulsifier selected from the group consisting of polysorbates, mono-glycerides, di-glycerides, poly-glycerol esters, propylene glycol esters, sorbitan esters and any combination thereof, such as sorbitan-tri-stearate.

In still further embodiments of the invention the fat phase has a weight-ratio between
triglycerides having C18 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,

which is between 0.40-0.99, such as 0.45-0.99, such as 0.50-0.99, such as 0.55-0.99, such as 0.60-0.99, such as 0.65-0.99, such as 0.70-0.99

In still further embodiments of the invention the fat phase of the inventive chocolate has a weight-ratio between
triglycerides having C18 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,

which is between 0.40 and 0.50. One advantage of this embodiment may that a combination of a relatively bloom-stable chocolate with good texture and sensoric properties. This may be particularly advantageous when using an emulsifier not being lecithin, for example an emulsifier selected from the group consisting of polysorbates, mono-glycerides, di-glycerides, poly-glycerol esters, propylene glycol esters, sorbitan esters and any combination thereof, such as sorbitan-tri-stearate.

In the present context it should be understood that the weight-ratio of the above embodiment is the weight-ratio between Sat(C18-C20)OSat(C18-C20) triglycerides and Sat(C16-C20)OSat(C16-C20) triglycerides, wherein said Sat(C18-C20)OSat(C18-C20) triglycerides are triglycerides having C18-C20 saturated fatty acids in the sn-1 and sn-3 positions and oleic acid in the sn-2 position, and wherein said Sat(C16-C20)OSat(C16-C20) triglycerides are triglycerides having C16-C20 saturated fatty acids in the sn-1 and sn-3 positions and oleic acid in the sn-2 position.

Triglycerides having C18-C20 saturated fatty acids in the sn-1 and sn-3 positions and oleic acid in the sn-2 position” are examples of SatOSat triglycerides. It should be understood that the saturated fatty acids in the sn-1 and the sn-3 positions may not necessarily be the same, although they may be in some cases. Examples of such triglycerides include StOSt, StOA, AOA.

Triglycerides having C18-C20 saturated fatty acids in the sn-1 and sn-3 positions and oleic acid in the sn-2 position of the triglycerides may also comprise a combination of two or more of the triglycerides StOSt, StOA, AOA, where these triglycerides are comprised in an amount of 30.0-99.0% by weight of the triglycerides having C18-C20 saturated fatty acids in the sn-1 and sn-3 positions and oleic acid in the sn-2 position, such as 40.0-99.0% by weight, such as 50.0-99.0% by weight, such as 60.0-99.0% by weight, such as 70.0-99.0% by weight.

The fat phase may further comprise triglycerides other than triglycerides having C18-C20 saturated fatty acids in the sn-1 and sn-3 positions and oleic acid in the sn-2 position of the triglycerides. Such other triglycerides may include for example BOB and LigOLig-triglycerides.

In an embodiment of the invention said seed composition comprises 60.0-99.9% by weight of triglycerides, such as 70.0-99.9% by weight, such as 80.0-99.9% by weight, such as 90.0-99.9% by weight, such as 95.0-99.9% by weight.

In an embodiment of the invention said seed composition comprises 40.0-99.0% by weight of triglycerides having C18-C20 saturated fatty acids in the sn-1 and sn-3 positions and oleic acid in the sn-2 position of the triglyceride, such as 50.0-99.0% by weight, such as 60.0-99.0% by weight, such as 70.0-99.0% by weight and the seed composition may advantageously comprise StOSt-triglycerides in an amount of 40-90% by weight, such as 50-90%, such as 50-80% wherein St stands for stearic acid and O stands for oleic acid. The StOSt-triglycerides are part of C18-20 triglycerides.

In still a further embodiment of the invention the seed composition may comprise AOA-triglycerides in an amount of 40-90% by weight, such as 50-90%, such as 50-80% wherein St stands for stearic acid and O stands for oleic acid. The AOA-triglycerides are part of C18-20 triglycerides.

The seed composition may further comprise triglycerides other than triglycerides having C18-C20 saturated fatty acids in the sn-1 and sn-3 positions and oleic acid in the sn-2 position of the triglycerides. Such other triglycerides may include for example BOB and LigOLig-triglycerides.

According to an embodiment of the invention, the fat phase comprises fat obtained from vegetable sources.

In a further embodiment of the invention the seed product fat is obtained from vegetable sources. These sources may include vegetable fat selected from a group consisting of fats obtained from shea, sal, kokum, illipe, mango, mowra, cupuacu, allanblackia, pentadesma and any fraction and any combination thereof.

In a further embodiment of the invention the seed composition comprises triglycerides obtained from non-vegetable sources in an amount of 1.0-99.9% by weight, such as 5.0-99.9% by weight, such as 50.0-99.9% by weight.

In a further embodiment said seed composition comprises triglycerides obtained from non-vegetable sources in an amount of at least 1% by weight, such as at least 2% weight, such as at least 5% by weight.

In a further embodiment said fat phase comprises triglycerides obtained from non-vegetable sources in an amount more that 5% by weight, such as 10% by weight.

In a further embodiment said seed composition comprises triglycerides obtained from unicellular organisms in an amount of 1.0-99.9% by weight, such as 5.0-99.9% by weight, such as 50.0-99.9% by weight.

According to an embodiment of the invention, said fat phase comprises triglycerides obtained from unicellular organisms in an amount of 0.1-99.9% by weight, such as 1-20%, such as 1-15%, such as 2-10%, such as 5-10%.

The triglycerides obtained from unicellular organisms are part of the triglycerides obtained from non-vegetable sources.

The unicellular organisms may for example be selected from the group consisting of bacteria, algae or fungi, wherein fungi comprise yeast and mold.

According to an embodiment of the invention said fat phase comprises 1.0-50.0% of StOSt-triglycerides obtained from unicellular organisms by weight of said fat phase, such as 5.0-50.0% by weight, such as 20.0-50.0% by weight, such as 30.0-40.0% by weight.

According to an embodiment of the invention said seed composition comprises 40.0-99.0% of StOSt-triglycerides obtained from unicellular organisms by weight of said seed composition, such as 50.0-99.0% by weight, such as 60.0-99.0% by weight, such as 70.0-99.0% by weight.

According to an embodiment of the invention said seed composition comprises 40.0-99.0% of AOA-triglycerides obtained from unicellular organisms by weight of said seed composition, such as 50.0-99.0% by weight, such as 60.0-99.0% by weight, such as 70.0-99.0% by weight.

In a further embodiment said seed composition comprises triglycerides obtained by transesterification in an amount of 1.0-99.9% by weight, such as 5.0-99.9% by weight, such as 50.0-99.9% by weight.

The triglycerides obtained by transesterification are part of the triglycerides obtained from non-vegetable sources.

According to an embodiment of the invention said fat phase comprises 1.0-50.0% of StOSt-triglycerides obtained by transesterification by weight of said fat phase, such as 5.0-50.0% by weight, such as 20.0-50.0% by weight, such as 30.0-40.0% by weight.

According to an embodiment of the invention said seed composition comprises 40.0-99.0% of StOSt-triglycerides obtained by transesterification by weight of said seed composition, such as 50.0-99.0% by weight, such as 60.0-99.0% by weight, such as 70.0-99.0% by weight.

According to an embodiment of the invention said seed composition comprises 40.0-99.0% of AOA-triglycerides obtained by transesterification by weight of said seed composition, such as 50.0-99.0% by weight, such as 60.0-99.0% by weight, such as 70.0-99.0% by weight.

In an embodiment of the invention, the triglycerides obtained by transesterification comprises triglycerides obtained from an edible fat and a saturated fatty acid source under the influence of enzymes having 1,3-specific transesterification activity.

In an embodiment of the process of the invention and all its embodiments, the triglycerides obtained by transesterification comprises triglycerides obtained from an edible fat and a saturated fatty acid source under the influence of an acid or a base.

In an embodiment of the invention, the saturated fatty acid source comprises stearic acid or stearic acid esters, such as stearic acid methyl ester. The saturated fatty acid source may as alternative thereto or in combination therewith comprise one or more from the group consisting of arachidic acid and/or arachidic acid esters, such as arachidic acid methyl ester, behenic acid and/or behenic acid esters, such as behenic acid methyl ester, and lignoceric acid and/or lignoceric acid esters, such as lignoceric acid methyl ester.

In an embodiment of the invention, the edible fat used for transesterification comprises vegetable fat selected from the group consisting of fats obtained from shea, sunflower, rapeseed, sal, soy, safflower, palm, kokum, illipe, mango, mowra, cupuacu and any fraction and any combination thereof.

In an embodiment of the invention, the edible fat used for transesterification comprises vegetable fat selected from the group of high oleic sunflower, high oleic safflower oil, high oleic rapeseed oil or any combination thereof.

In an embodiment of the invention, the edible fat used for transesterification comprises or consists of shea olein or a shea olein fraction.

The fat phase and/or seed product may comprise a certain level of lower melting oils. Thus, in an embodiment of the invention, the fat phase comprises oils with a melting point below 25 degrees Celsius in an amount of 1.0-42% by weight, such as 3.0-35% by weight, such as 3.5-27%, such as 5-20% by weight.

In an embodiment of the invention, the fat phase and/or seed product comprises oils selected from the group consisting of sunflower oil, high oleic sunflower oil, soybean oil, rape seed oil, high oleic rape seed oil, soy oil, olive oil, maize oil, peanut oil, sesame oil, hazelnut oil, almond oil, corn oil, or fractions or mixtures or any combination thereof.

In a further embodiment said chocolate comprises Form VI crystals of triglycerides having C18-C20 saturated fatty acids in the sn-1 and sn-3 positions of the triglyceride and oleic acid in the sn-2 position of the triglyceride.

In a further embodiment said seed composition comprises less than 10% by weight of BOB-triglycerides, such as less than 5% by weight, such as less than 1% by weight, wherein B stands for behenic acid and O stands for oleic acid.

According to an advantageous embodiment of the invention, the confectionery product according to any of its embodiments comprises less than 10% by weight of BOB-triglycerides, such as less than 5% by weight, such as less than 1% by weight, wherein B stands for behenic acid and O stands for oleic acid. The low amount of BOB triglycerides facilitates an advantageous texture of the chocolate both before and after the heat treatment.

According to an embodiment of the invention, said seed composition is substantially free of BOB-triglycerides, wherein B stands for behenic acid and O stands for oleic acid. A very advantageous property of the present confectionery product is when said chocolate is substantially free BOB-triglycerides. In practice it is difficult to measure the BOB-triglyceride content in the chocolate when the amount of this is less than 0.1 by weight. The very low content of BOB-triglycerides in the chocolate in combination with the effective seeding obtained by seed crystals of triglycerides having C18-C20 saturated fatty acids in the sn-1 and sn-3 positions of the triglyceride and oleic acid in the sn-2 position of the triglyceride facilitates a very attractive texture due to the fact that the available high form seed crystals, such as form VI crystals, in the chocolate has acceptable rheological combined with the fact that the chocolate may recover the texture even after the chocolate has been subject to relatively high heating. Thereby the chocolate becomes both texture-stable while at the same time having an attractive texture prior to any elevated critical temperatures where the chocolate will partly melt.

In other words the present confectionery product may have an attractive texture while at the same time be able to recover this advantageous texture at unprecedented elevated temperatures.

In a further embodiment the fat phase comprises 0.01-7%, such as 0.01- to 5% by weight of an emulsifier not being lecithin.

According to an advantageous embodiment of the invention said emulsifier not being lecithin is selected from the group consisting of polysorbates, mono-glycerides, di-glycerides, poly-glycerol esters, propylene glycol esters, sorbitan esters and any combination thereof.

According to a further advantageous embodiment said emulsifier not being lecithin comprises or consists of sorbitan-tri-stearate (STS).

The applied non-lecithin emulsifiers are very advantageous when applied in the chocolate according to its embodiment and may significantly promote the functionality of the applied seed

In a further embodiment the chocolate comprises further emulsifier in the amount of 0.01- to 5% by weight of the chocolate wherein the emulsifier comprises or is lecithin based on sunflower or rapeseed.

In a further embodiment the chocolate comprises retention improvers such as water in an amount of above 0.5%, such as 1%, such 2% by weight of said chocolate.

In a further embodiment of the invention the confectionery product comprises chocolate, wherein the chocolate has a fat phase comprising
60.0-99.9% by weight of triglycerides,
40.0-99.0 by weight of triglycerides having C16-C20 saturated fatty acids in the sn-1 and sn-3 positions of the triglyceride and oleic acid in the sn-2 position of the triglyceride and

wherein the chocolate has a texture ratio of between 0.80 and 1.10,

In a further embodiment of the invention the confectionery product comprises chocolate,

wherein the chocolate has a fat phase comprising
60.0-99.9% by weight of triglycerides,
40.0-99.0 by weight of triglycerides having C16-C20 saturated fatty acids in the sn-1 and sn-3 positions of the triglyceride and oleic acid in the sn-2 position of the triglyceride,

wherein the chocolate has a texture ratio of between 0.8 and 1.1,

wherein the texture ratio determines the increase between an initial texture value and a subsequent texture value,

wherein the initial texture value is measured prior to a temperature treatment and

wherein the subsequent texture value is measured subsequent to the temperature treatment,

wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer and wherein the chocolate comprises emulsifiers selected from the group consisting of polysorbates, mono-glycerides, di-glycerides, poly-glycerol esters, propylene glycol esters, sorbitan esters and any combination thereof.

The invention also relates to a process according to all embodiment of the invention wherein the seed is added in an amount, such that the fat phase of the seeded chocolate composition (SCC) has a weight-ratio between
triglycerides having C18-C24 saturated fatty acids in the sn-1 and sn-3 positions of the triglyceride and oleic acid in the sn-2 position of the triglyceride, and
triglycerides having C16-C24 saturated fatty acids in the sn-1 and sn-3 positions of the triglyceride and oleic acid in the sn-2 position of the triglyceride, which is between 0.40 and 0.50.

The invention also relates to a method for producing a confectionery product according to all embodiments of the invention where the confectionery product comprises chocolate,

wherein the chocolate has a fat phase comprising
60.0-99.9% by weight of triglycerides,
40.0-99.0 by weight of triglycerides having C16-C20 saturated fatty acids in the sn-1 and sn-3 positions of the triglyceride and oleic acid in the sn-2 position of the triglyceride,

wherein the chocolate has a texture ratio of between 0.8 and 1.1,

wherein the texture ratio determines the increase between an initial texture value and a subsequent texture value,

wherein the initial texture value is measured prior to a temperature treatment and wherein the subsequent texture value is measured subsequent to the temperature treatment,

wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer.

### EXAMPLES

The invention is now illustrated by way of examples.

### Example 1

### Milk Chocolate of Reference-, Comparative- and Inventive Compositions

Tables 1 below show the recipes and the fat compositions for milk chocolates.

Milk chocolates I, II and III were each hand tempered on marble table and used to produce 100 gram chocolate tablets.

The milk chocolates IV was stirred at 35 degrees Celsius in an open bowl. The seed, in a slurry like state at 39 degrees Celsius was added to the chocolates and mixed for 15 minutes. Thereafter, the chocolates were poured into 100 g chocolate tablet molds.

The molds were subsequently cooled in a three zones cooling tunnel for a total of 30 minutes, first 10 minutes at a temperature of 15 degrees Celsius, followed by 10 minutes at a temperature at 12 degrees Celsius, followed by 10 minutes at a temperature of 15 degrees Celsius.

Weight percentages in table 2 below refer to the total recipe and to the fat composition, respectively.

TABLE 1
Seed fat composition (enzymatically prepared StOSt)
Fat composition of seed

| | |
|---|---|
| Enzymatically produced SatOSat (% w/w) | 79.0 |
| Enzymatically produced StOSt (% w/w) | 66.0 |
| Ratio StOSt/SatOSat | 0.84 |
| Sat2OSat2 (% w/w)* | 69.1 |
| Ratio Sat2OSat2/SatOSat | 0.87 |

Sat2OSat2* = triglycerides having C18-C20 saturated fatty acids in the sn-1 and sn-3 positions and oleic acid in the sn-2 position. The endotherm melt peak position of the seed has been processed to be between 42 and 43 degrees Celsius.

TABLE 2
Recipes and fat compositions for milk chocolates. Ratios
are not given in %, but as fractions between 0 and 1.

| | Milk | Milk | Milk | Milk |
|---|---|---|---|---|
| Recipe | Chocolate I | Chocolate | Chocolate | Chocolate |
| (in % w/w) | (Reference) | II | III | IV |
| Seed | — | — | — | 1.0 |
| Enzymatic StOSt | — | 4.6 | 7.7 | 3.6 |
| Cocoa butter | 17.3 | 12.7 | 9.6 | 12.7 |
| Cocoa mass | 15.9 | 15.9 | 15.9 | 15.9 |
| Sugar | 43.6 | 43.6 | 43.6 | 43.0 |
| Skim milk powder | 5.0 | 5.0 | 5.0 | 5.0 |
| Whole milk powder | 17.8 | 17.8 | 17.8 | 17.8 |
| Lecithin | 0.4 | 0.4 | 0.4 | 0.4 |
| STS | — | — | — | 0.6 |

Fat composition

| | | | | |
|---|---|---|---|---|
| Seed slurry (%) | — | — | — | 3 |
| Enz StOSt (%) | — | 15 | 25 | 12 |
| Cocoa butter (%) | 85 | 70 | 60 | 70 |
| Milk fat (%) | 15 | 15 | 15 | 15 |
| Total fat content | 30.9 | 30.9 | 30.9 | 30.9 |
| (% w/w) | | | | |

The comprised fat composition for chocolate
without milk fat (no seed added)

| | | | | |
|---|---|---|---|---|
| STS (% w/w) | — | — | — | 2.0 |
| SatOSat (% w/w) | 82.1 | 81.6 | 81.2 | 81.6 |
| StOSt (% w/w) | 27.1 | 33.9 | 38.5 | 33.9 |
| Ratio StOSt/SatOSat | 0.33 | 0.42 | 0.47 | 0.42 |
| Sat2OSat2 (% w/w)* | 28.9 | 35.9 | 40.7 | 35.9 |
| Ratio | 0.35 | 0.44 | 0.50 | 0.44 |
| Sat2OSat2/SatOSat | | | | |

Sat2OSat2* = triglycerides having C18-C20 saturated fatty acids in the sn-1 and sn-3 positions and oleic acid in the sn-2 position. “Ratio StOSt/SatOSat” denotes the weight-ratio between StOSt triglycerides and SatOSat triglycerides, whereas “Ratio Sat2OSat2/SatOSat” denotes the weight-ratio between Sat2OSat2 triglycerides and SatOSat triglycerides. The enzymatically prepared StOSt source may also be referred to as “enzymatic StOSt”

The total fat content in the recipe is calculated as the sum of shea stearin, CB, fat content of the cocoa mass (approx. 56% cocoa butter in cocoa mass), milk fat and the fat content of skim milk powder.

Emulsifier not being lecithin (here STS), when added, is thus present in an amount of approx. 2% by weight of the total fat content.

An indication that the illustrated Milk Chocolate IV may benefit from an improved texture can been deduced by the fact the Milk Chocolate IV has an endotherm melt peak position which is higher than the main endotherm melt peak position of Milk Chocolates I-III.

### Example 2

### Texture of Milk Chocolate Tablets

After 7 days storage at 20 degrees Celsius (+/−0.5 degrees Celsius) the milk chocolate tablets from example 1 were subjected first to heat treatment A and the subsequently to heat treatment B.

Heat treatment A: Samples stored at 25 degrees Celsius 25+/−0.5 degrees Celsius for 24 hours

Heat treatment B: Samples placed in a programmable temperature cabinet and subjected to heat treatment at a 37 degrees Celsius (+/−0.5 degrees Celsius) for 10 hours followed by 25 degrees Celsius (+/−0.5 degrees Celsius) for 24 hours.

The texture of the milk chocolate bars was determined after exposure heat treatment A and B. The texture analysis were measured on a Texture analyzer TA-XT2i with Stable Micro Systems 2 mm needle probe P2N set to penetrate 3 mm into the chocolate samples at 0.5 mm/sec. A total of 8 measurements per sample were performed. Samples were measured at 25 degrees Celsius±0.5 degrees Celsius.

The settings of the Texture analyzer TA-XT2i were:

TA-settings: for solid chocolate bars

Mode: Measure Force in Compression

Option: Return to start

Pre-Test Speed: 2.0 mm/s

Test-Speed: 0.5 mm/s

Post-Test Speed: 10.0 mm/s

Distance: 3.0 mm

Trigger Type: Auto—5 g

Data Acquisition Rate: 100 pps

Target mode is set to Distance.

Probe:

P/2N Needle/5 kg load cell

Test Results:

Hardness Force in g
Std dev in g

The below tables designation of gram Force thus refer to a measured unit where force is measured in gram. The standard deviation (std. dev) is given in the same unit i.e. in gram. The texture ratio (Texture after heat treatment/Texture before heat treatment) is thus a relative unit which is gram/gram; hence it is a dimensionless quantity.

TABLE 3
Texture results after heat treatments A and B for milk chocolates.

| | | | | |
|---|---|---|---|---|
| | Milk | Milk | Milk | Milk |
| | Chocolate I | Chocolate | Chocolate | Chocolate |
| Texture | (Reference) | II | III | IV |

Heat treatment A: 25° C. for 24 hours

| | | | | |
|---|---|---|---|---|
| Texture average | 323 | 374 | 421 | 382 |
| (gram Force) | | | | |
| Texture std. dev. | 13 | 11 | 11 | 7 |
| (gram Force) | | | | |

Heat treatment B: 10 hours at 37° C. and 24 hours at 25° C.

| | | | | |
|---|---|---|---|---|
| Texture average | 0 | 425 | 499 | 395 |
| (gram Force) | | | | |
| Texture std. dev. | — | 11 | 19 | 18 |
| (gram Force) | | | | |
| Texture ratio: | 0 | 1.14 | 1.19 | 1.03 |
| Texture after heat | | | | |
| treatment/Texture | | | | |
| before heat treatment | | | | |

As shown in Table 3 it is noted that the texture ratio rise significantly for Milk Chocolate II and III, whereas the seed Chocolate maintains/recover the textural properties in spite of the aggressive heating at 37 degrees Celsius and the temperature. The Milk Chocolate I was not even recrystallised after 24 hours at 25 C after heat treatment. Thus texture ratio of 0. The reason why milk chocolate II and III have higher texture after heat treatment than before is assumed to be a result of the polymorphic transformations (Form IV to V and V-VI) taken place during the 24 hours at 37 degrees Celsius resulting in bloom formation. Thus ratios 1.14 and 1.19 respectively.

### Example 3

### Sensoric Properties of Milk Chocolate Tablets

Furthermore, chocolate samples exposed to heat treatments A and B were evaluated by a sensory panel to determine if the chocolate samples have a chocolate like sensory with respect to waxiness, brittleness and sandiness. The samples were evaluated at 25+/−0.5 degrees Celsius

TABLE 4
Sensorial results with respect to chocolate like sensory
after heat treatments A and B for milk chocolates.

| | | | | |
|---|---|---|---|---|
| | Milk | Milk | Milk | Milk |
| | Chocolate I | Chocolate | Chocolate | Chocolate |
| Sensory | (Reference) | II | III | IV |

Heat treatment A: 25° C. for 24 hours

| | | | | |
|---|---|---|---|---|
| Waxiness | OK | OK | — | OK |
| Brittleness | OK | OK | OK | OK |
| Sandiness | OK | OK | OK | OK |

Heat treatment B: 10 hours at 37° C. and 24 hours at 25° C.

| | | | | |
|---|---|---|---|---|
| Waxiness | — | OK | — | OK |
| Brittleness | — | — | — | OK |
| Sandiness | — | — | — | OK |

“OK” denotes a sensory which the sensory panel describe as chocolate like sensory
“—” denotes a sensory which the sensory panel do not describe as chocolate like sensory

Finally, chocolate samples exposed to heat treatments A and B were evaluated for bloom. The samples were evaluated at 25+/−0.5 degrees Celsius.

TABLE 5
Bloom on milk chocolate samples

| | | | | | |
|---|---|---|---|---|---|
| Recipe | Test | Test | Test | Test | Test |
| (in % w/w) | chocolate | chocolate | chocolate | chocolate | chocolate |

| | | | | |
|---|---|---|---|---|
| | Milk | Milk | Milk | Milk |
| | Chocolate I | Chocolate | Chocolate | Chocolate |
| Bloom | (Reference) | II | III | IV |

Heat treatment A: 25 degrees Celsius for 24 hours

| | | | | |
|---|---|---|---|---|
| Bloom evaluation | ++ | ++ | ++ | ++ |

Heat treatment B: 10 hours at 37 degrees Celsius
and 24 hours at 25 degrees Celsius

| | | | | |
|---|---|---|---|---|
| Bloom evaluation | * | − | − | ++ |

“++” denotes a glossy and un-bloomed chocolate surface
“+” denotes a dull but un-bloomed chocolate surface
“−” denotes a bloomed chocolate surface
“*” denotes a liquid chocolate surface without crystals to form bloom

It is noted that both the sensory results in table 4 and the bloom evaluation in table 5 confirms that the chocolate properties of Milk Chocolates I to III loses the original texture and mouthfeel whereas the Milk Chocolate IV retain/recover the textural properties like waxiness, brittleness and sandiness.

The below Table 6 illustrates comparative examples of different Test Chocolates A-E where the main difference between the chocolates are the use of different types of emulsifiers.

TABLE 6
Comparative examples with different emulsifiers

| | A | B | C | D | E |
|---|---|---|---|---|---|
| Seed | 1.0 | 1.0 | 1.0 | 1.0 | 1.0 |
| Enzymatic StOSt | 3.6 | 3.6 | 3.6 | 3.6 | 3.6 |
| Cocoa butter | 12.7 | 12.7 | 12.7 | 12.7 | 12.7 |
| Cocoa mass | 15.9 | 15.9 | 15.9 | 15.9 | 15.9 |
| Sugar | 43.0 | 43.0 | 43.0 | 43.0 | 43.0 |
| Skim milk | 5.0 | 5.0 | 5.0 | 5.0 | 5.0 |
| powder | | | | | |
| Whole milk | 17.8 | 17.8 | 17.8 | 17.8 | 17.8 |
| powder | | | | | |
| Lecithin | 0.4 | 0.4 | 0.4 | 0.4 | 0.4 |
| STS (sorbitan- | — | — | — | — | 0.6 |
| tristearate) | | | | | |
| PGPR | — | — | — | 0.6 | — |
| (Polyglycerol | | | | | |
| polyricinoleate) | | | | | |
| E 471 | — | — | 0.6 | — | — |
| E 433 | — | 0.6 | — | — | — |
| (Polysorbate 80) | | | | | |
| PGMS | 0.6 | — | — | — | — |
| (Polypropylene | | | | | |
| glycol | | | | | |
| monostearate) | | | | | |

1-30. (canceled)

31. A composition comprising chocolate,
wherein the chocolate has a fat phase comprising:
60.0-99.9% by weight of triglycerides,
5 40.0-99.0 by weight of triglycerides having C16-C20 saturated fatty acids in the sn-1 and sn-3 positions of the triglyceride and oleic acid in the sn-2 position of the triglyceride,
wherein the chocolate has a texture ratio of between 0.8 and 1.1,
wherein the texture ratio determines the increase between an initial texture value and a subsequent texture value,
wherein the initial texture value is measured prior to a temperature treatment and
wherein the subsequent texture value is measured subsequent to the temperature treatment,
wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a texture analyzer.

32. The composition of claim 31, wherein the temperature treatment is obtained by providing five samples said chocolate and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius for 24 hours and wherein the initial and the subsequent texture values are measured on a Stable Micro System texture analyzer TA-XT2i with a Stable Micro Systems 2 mm needle probe P2N set to penetrate into the samples at 0.5 mm/second and wherein the samples are measured at 25+/−0.5 degrees Celsius.

33. The composition of claim 32, wherein said Stable Micro Systems 2 mm needle probe P2N is set to a penetration of at least 1 millimeters into the samples.

34. The composition of claim 31, wherein the temperature treatment is obtained by providing five samples of said chocolate each weighing 100 grams and storing these at 25+/−0.5 degrees Celsius for 24 hours and then inserting them into a temperature cabinet and subjecting them to a heat treatment at a high temperature of 37+/−0.5 degrees Celsius for 10 hours followed by a low temperature of 25+/−0.5 degrees Celsius 24 hours, and
wherein the initial and the subsequent texture values are measured on a Stable Micro System texture analyzer TA-XT2i with a Stable Micro Systems 2 mm needle probe P2N set to penetrate 3 mm into the samples at 0.5 mm/second and wherein the samples are measured at 25+/−0.5 degrees Celsius.

35. The composition of claim 31, where the measured texture values are obtained as an average of the measured texture values across a measuring sequence of measures on said samples.

36. The composition of claim 31, where a standard deviation of the measured texture values are less than about +/−20% over a measuring sequence of measures on said samples.

37. The composition of claim 31, wherein said chocolate is forming a confectionery product.

38. The composition of claim 31, wherein said chocolate is forming at least a part of a confectionery product.

39. The composition of claim 31, wherein said chocolate is forming a coating of a confectionery product.

40. The composition of claim 31, wherein said chocolate has an endotherm melt peak position at least 37 degrees Celsius on a DSC melting thermogram of said chocolate and wherein said a DSC melting thermogram is measured by differential scanning calorimetry by heating samples of 10+/−1 mg of said chocolate from 20 degrees Celsius to 65 degrees Celsius at a rate of 3 degrees Celsius/min to produce a melting thermogram defining first and second endotherm melt peak positions.

41. The composition of claim 40, wherein said endotherm melt peak position is at least 37.2 degrees Celsius.

42. The composition of claim 40, wherein said endotherm melt peak position has a minimum intensity of 0.1 J/g where the minimum intensity is measured as Joule/gram.

43. The composition of claim 31, wherein said chocolate comprises sugar having a particle size of less than 50 micrometers.

44. The composition of claim 31, wherein said composition comprises a crystalline seed product comprising a seed composition.

45. The composition of claim 31, wherein said fat phase comprises 70.0-99.9% by weight of triglycerides.

46. The composition of claim 31, wherein the fat phase comprises 50.0-99.0% by weight of triglycerides having C16-C20 saturated fatty acids in the sn-1 and sn-3 positions and oleic acid in the sn-2 position of the triglyceride.

47. The composition of claim 31, wherein the fat phase has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,
which is between 0.40-0.99.

48. The composition of claim 44, wherein the crystalline seed product fat is obtained from vegetable sources.

49. The composition of claim 44, wherein the seed composition comprises triglycerides obtained from non-vegetable sources in an amount of 1.0-99.9% by weight.

50. The composition of claim 31, wherein said fat phase comprises triglycerides obtained from non-vegetable sources in an amount more that 5% by weight.

51. The composition of claim 44, wherein said seed composition comprises triglycerides obtained from unicellular organisms in an amount of 1.0-99.9% by weight.

52. The composition of claim 44, wherein said seed composition comprises triglycerides obtained by transesterification in an amount of 1.0-99.9% by weight.

53. The composition of claim 31, wherein said chocolate comprises Form VI crystals of triglycerides having C18-C20 saturated fatty acids in the sn-1 and sn-3 positions of the triglyceride and oleic acid in the sn-2 position of the triglyceride.

54. The composition of claim 31, wherein said seed composition comprises less than 10% by weight of BOB-triglycerides, wherein B stands for behenic acid and 0 stands for oleic acid.

55. The composition of claim 31, wherein said fat phase is substantially free of BOB-triglycerides.

56. The composition of claim 31, wherein the fat phase comprises 0.01-7% by weight of an emulsifier not being lecithin.

57. The composition of claim 31, wherein the chocolate further comprises emulsifier in the amount of 0.01- to 5% by weight of the chocolate wherein the emulsifier comprises lecithin based on sunflower or rapeseed.

58. The composition of claim 31, wherein the chocolate comprises retention improvers in an amount of above 0.5% by weight of said chocolate.

59. The composition of claim 31, wherein the fat phase has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,
which is between 0.40-0.99.

60. The composition of claim 31, wherein the fat phase has a weight-ratio between
triglycerides having C18-C20 saturated fatty acids in the sn-1 and sn-3 positions of the triglyceride and oleic acid in the sn-2 position of the triglyceride, and
triglycerides having C16-C20 saturated fatty acids in the sn-1 and sn-3 positions of the triglyceride and oleic acid in the sn-2 position of the triglyceride,
which is between 0.40 and 0.50.
